(19) United States
(12) Patent Application Publication
(10) Pub. No.: US 2005/0056116 A1
(43) Pub. Date: Mar. 17, 2005

(54) Gearshift knob

(76) Inventor: Hsi-Lung Tsai, Hua-Tan Hsiang (TW)

Correspondence Address: VENABLE, BAETJER, HOWARD AND CIVILETTI, LLP, P.O. BOX 34385, WASHINGTON, DC, 20043-9998, US

(21) Appl. No.: 10/660,479

(22) Filed: Sep. 12, 2003

(51) Int. Cl. G05G 1/04

(52) U.S. Cl. 74/523

(57) ABSTRACT

A gearshift knob includes a body and a solid pattern. The body has a grip and a top. The solid pattern is formed either on the top or the grip of the body and could be a company logo, significant symbol, trademark etc. Consequently, the solid pattern makes the gearshift knob to be more frictional and provides an improved feeling to prevent a situation of the gearshift slipping out of a hand when a driver holds the gearshift knob to change gears. Also, the solid pattern makes the gearshift knob more attractive to consumers. Furthermore, because the solid pattern could be a company logo or trademark, the gearshift knob with the solid pattern will promote the company image to the consumers.

### BACKGROUND OF THE INVENTION

1. Field of the Invention

The present invention relates to a gearshift knob, and more particularly to a gearshift knob that has a solid pattern not only to provide an improved grip to prevent the gearshift knob from slipping out of a driver's hand but also for decoration.

2. Description of Related Art

Drivers use a gearshift column to change gears in a vehicle and the gears change power into movement. With reference to FIG. 3, a gearshift column (50) is typically a metal lever with a top (not shown). A gearshift knob (51) in accordance with the prior art is attached to the top of the gearshift column (50) for a driver to hold. The gearshift knob (51) has a grip (511) and an enlarged top (512) so the driver can hold the grip (511) with fingers and the driver's thumb can press on the enlarged top (512) to move the gearshift column (50).

However, because the gearshift knob (51) in accordance with the prior art does not have any protrusions on its surface, the gearshift knob (51) easily slips from the driver's hand as the driver holds the gearshift knob (51) to change the gears. Such a situation is really hazardous when the vehicle is moving as the speed of the vehicle may drastically and suddenly change.

Besides, as the gearshift knob (51) does not have any attractive or significant patterns, icons or the like on it, the gearshift knob (51) is not attractive for consumers. Surfaces of the grip (511) and the enlarged top (512) are so unappealing that a consumer may not choose to purchase such a gearshift knob.

To overcome the shortcomings, the present invention provides an improved gearshift knob with a solid pattern to mitigate or obviate the aforementioned problems.

### SUMMARY OF THE INVENTION

The main objective of the invention is to provide an improved gearshift knob that has a solid pattern to provide an improved grip to prevent the gearshift knob from slipping out of a driver's hand when the driver holds the gearshift knob to change gears in a vehicle.

Another objective of the invention is to provide a gearshift knob that has a solid pattern to make the gearshift knob to look more attractive for consumers.

To achieve the aforesaid objectives, a gearshift knob in accordance with the present invention comprises a body and a solid pattern. The body has a grip and a top. The solid pattern is formed either on the top or the grip of the body and could be a company logo, significant symbol, trademark etc. Consequently, the gearshift knob with the solid pattern provides a frictional feeling to prevent the gearshift knob from slipping out of a hand when a driver holds the gearshift knob. Also, the gearshift knob with the solid pattern will look attractive so that a consumer will intend to purchase the gearshift knob. Furthermore, because the solid pattern could be a company logo or trademark, the gearshift knob with the solid pattern will promote the company image to the consumers.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a gearshift knob in accordance with the present invention;

FIG. 2 is an operational perspective view of an alternative embodiment of a gearshift knob in accordance with the present invention; and

FIG. 3 is an operational perspective view of a gearshift knob in accordance with prior art.

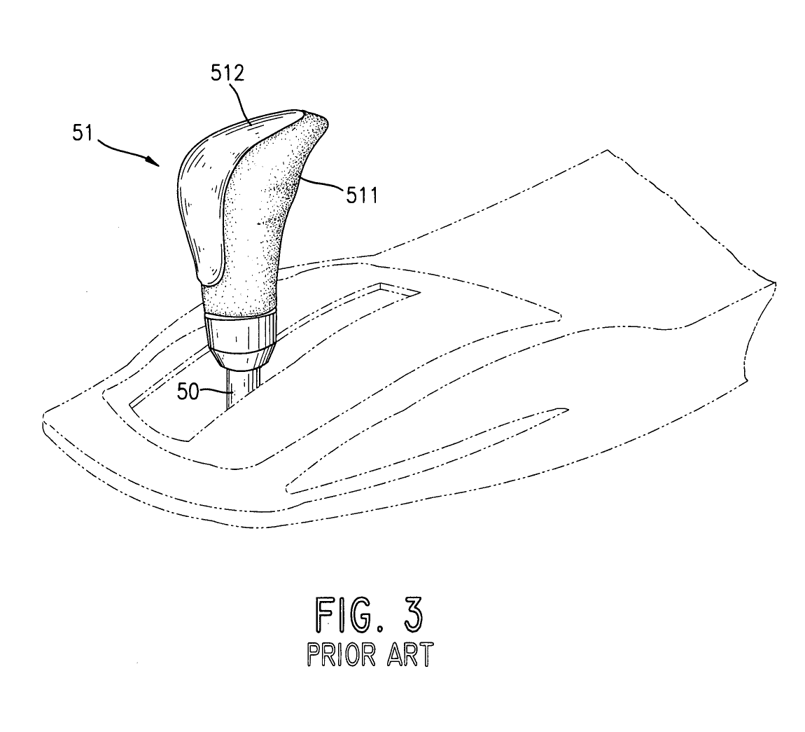

### DETAILED DESCRIPTION OF PREFERRED EMBODIMENT

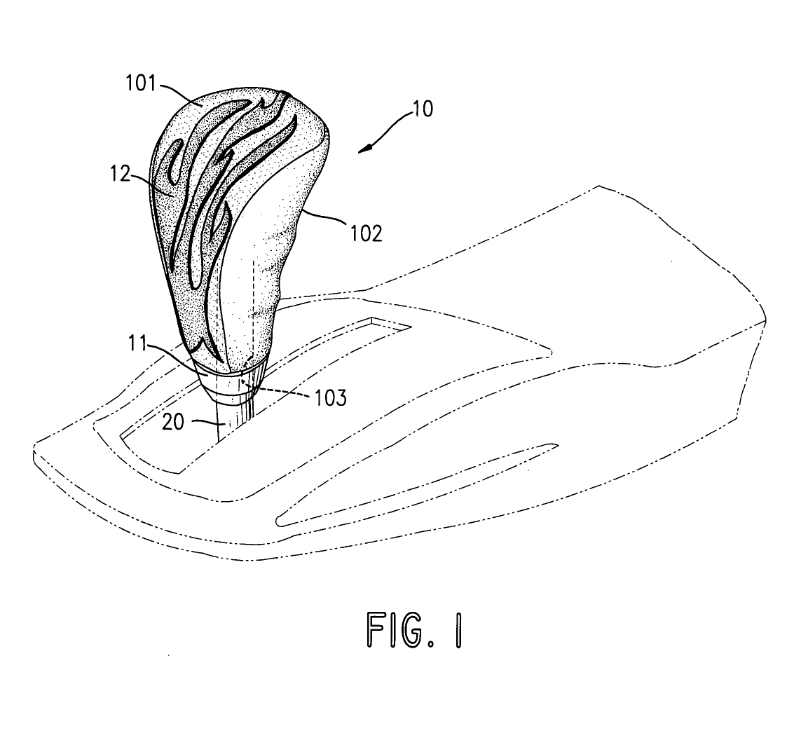

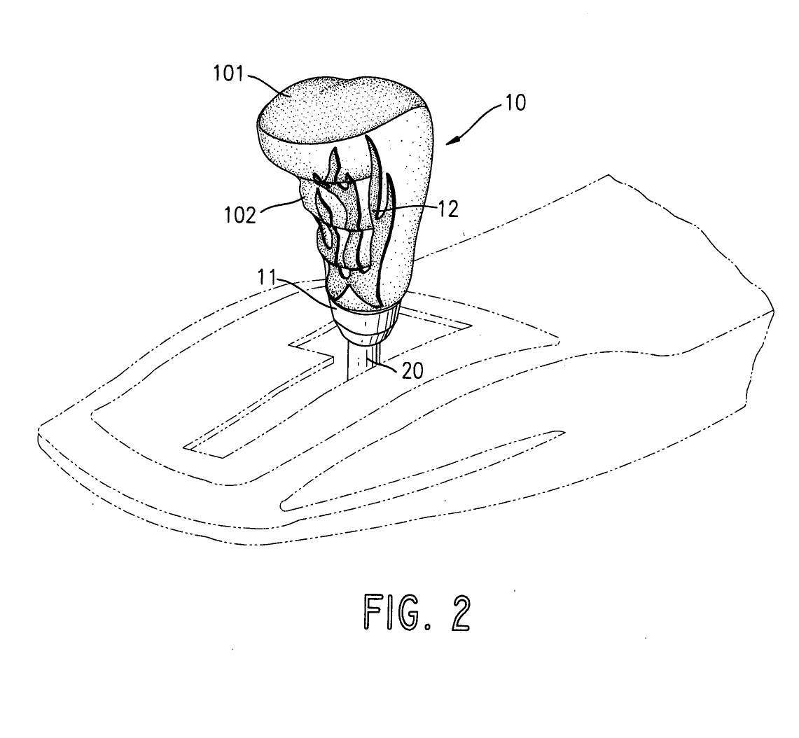

With reference to FIGS. 1 and 2, a gearshift knob (not numbered) in accordance with the present invention is adapted to mount on a gearshift column (20) connected with a gearbox (not shown) of a vehicle (not shown) and comprises a body (10), a covering ring (11) and a solid pattern (12). The body (10) has a top (101), a grip (102), a bottom (not numbered) and a bottom hole (103). The top (101) is enlarged for a driver's thumb to press conveniently thereon. The grip (102) is formed between the top and the bottom of the body (10) for the driver to hold, preferably by fingers only. The bottom hole (103) is defined in the bottom of the body (10) and is accommodated to receive the gearshift column (20) that changes gears in the vehicle.

The gearshift knob is attached to the gearshift column (20) by means of bolts (not shown) that are hidden by the covering ring (11) that is attached to the bottom of the body (10) to cover the bolts. Therefore, the appearance of the entire gearshift knob (10) is not unsightly.

The solid pattern (12) is formed on the body (10) which the driver will hold. The solid pattern (12) can be formed on the top of the body (10) and extends toward the bottom, as shown in FIG. 1. Otherwise, the solid pattern (12) can be formed on around the grip (102), as shown in FIG. 2. The solid pattern (12) could be made of soft materials, such as foam rubber or soft leather and shaped into a trademark, a significant symbol, a company logo, a letter, an interesting icon etc.

Since the solid pattern (12) protrudes from the body (10) to be three-dimensional, the gearshift knob will provide a frictional feeling as the driver holds the gearshift knob. The gearshift knob will not easily slip out of the hand and is thus superior to the prior art. Thus, to change the gears in a vehicle with the gearshift knob is performed in a safer way that prevents the driver from any potential hazards.

Furthermore, the solid pattern (12) will make the gearshift knob more attractive than the prior art. When a consumer looks at the decorated gearshift knob in a car accessory shop, the decorated gearshift knob will attract the consumer's attention and ensure purchase of the knob. Moreover, the solid pattern (12) can be used for business or advertising purposes to promote the company image to the consumers.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A gearshift knob adapted to mount a gearshift column connected with a gearbox of a vehicle, and comprising:
a body having a top, a grip, a bottom and a bottom hole formed in the bottom to mount the gearshift column; and
a solid pattern formed on the body and protruded from the body.

2. The gearshift knob as claimed in claim 1 further comprising a covering ring attached to the bottom of the body.

3. The gearshift knob as claimed in claim 2, wherein the top of the body is enlarged and the solid pattern is formed on the enlarged top and extends toward the bottom of the body.

4. The gearshift knob as claimed in claim 2, wherein the solid pattern is formed on the grip of the body.
